(19) United States
(12) Patent Application Publication
(10) Pub. No.: US 2025/0033639 A1
(43) Pub. Date: Jan. 30, 2025

(54) METHOD FOR DETECTING INCORRECT OPERATION OF A MOTOR VEHICLE

(71) Applicant: Dr. Ing. h. c. F. Porsche AG, Stuttgart (DE)

(72) Inventor: Christian Feil, Deisslingen (DE)

(73) Assignee: Dr. Ing. h. c. F. Porsche AG, Stuttgart (DE)

(21) Appl. No.: 18/783,912

(22) Filed: Jul. 25, 2024

(30) Foreign Application Priority Data
Jul. 27, 2023 (DE) 10 2023 119 897.1

(51) Int. Cl. B60W 30/14; B60W 50/14

(52) U.S. Cl. CPC B60W 30/146; B60W 50/14; B60W 2520/105

(57) ABSTRACT

A method for detecting and correcting an incorrect operation of a motor vehicle (80) includes using at least one sensor unit (20) for detecting (100) data indicative of a current acceleration behavior of a driver of the motor vehicle (80). The method then includes using a processing unit (22) for determining (200) the current acceleration behavior of the driver of the motor vehicle (80) based on the data indicative of the current acceleration behavior. The method further includes using a control unit (24) for reducing acceleration for operation of the motor vehicle (80) and thereby controlling (300) an operation of the motor vehicle (80) based on the determined current acceleration behavior.

### CROSS-REFERENCE TO RELATED APPLICATION

This application claims priority on German Patent Application No 10 2023 119 897.1 filed Jul. 27, 2023, the entire disclosure of which is incorporated herein by reference.

### BACKGROUND

### Field of the Invention

The invention relates to a method and system for detecting incorrect operation of a motor vehicle. Moreover, the invention relates to a motor vehicle comprising such a system.

### Related Art

A motor vehicle with a conventional internal combustion engine or alternative drive systems enables the driver to engage the operating point of the vehicle in an unloaded state with the clutch or drive train not closed. However, high-frequency accelerator pedal movements over a longer period of time (e.g., pressing the accelerator pedal twice per second, for example, over 1 minute), can place excessive thermal and mechanical loads on the motor vehicle and can lead to excessive emissions. Moreover, the generation of such states also increases the risk of unauthorized error memory entries in the drive system, as these states are not regular use cases.

Known methods and systems attempt to solve these problems but are either not reliable enough or very complex and costly. In addition, the known solutions are disadvantageous for safety reasons.

It is an object of the invention to at least partially remedy the disadvantages described above by providing a method and a system that detects and prevents incorrect operation of the motor vehicle in a simple, reliable, and cost-efficient manner by preventing excessive acceleration.

The disclosed technical features regarding the method of the invention also apply to the system and motor vehicle of the invention, and vice versa. Thus, reference always can be made mutually with resp to individual aspects of the invention.

### SUMMARY OF THE INVENTION

The invention relates to a method for detecting incorrect operation of a motor vehicle. Sone embodiments of the method comprise using a sensor for detecting data indicative of a current acceleration behavior of a driver of the motor vehicle, using a processing unit for determining from the detected data the current acceleration behavior of the driver of the motor vehicle, and using a control unit for controlling an operation of the motor vehicle based on the determined current acceleration behavior. More particularly, the control unit may respond to certain determined acceleration behaviors by reducing a maximum speed available for operating the motor vehicle.

Some embodiments of the method ensure vehicle-friendly operation with low emission loads in a simple, reliable, and cost-effective manner by controlling operation of the motor vehicle based on specific current acceleration behavior. Thus, the method may include reducing a maximum speed available for an operation of the motor vehicle when an improper acceleration behavior is detected.

The method disclosed herein can be used in motor vehicles, such as passenger vehicles or trucks. However, the method also can be used in other vehicles, such as commercial vehicles or the like.

Incorrect operation of a motor vehicle can be understood as an operation of a motor vehicle with an improper acceleration behavior, i.e., operation of a motor vehicle in which high speeds are measured continuously and not just occasionally, for example >3000 rpm or >4000 rpm. The indication of speeds may be adjusted with respect to different types of motor vehicles. Such a definition makes it possible to reliably differentiate between possible incorrect operation and regular use, such as necessary overtaking maneuvers.

The method steps disclosed herein can be performed by different units or even by only one unit, for example a central control unit.

An actuated accelerator pedal travel and/or an actuated accelerator pedal travel per time can be detected in a simple, rapid and cost-efficient manner and, in some embodiments, can provide or contribute to the data for detecting a current or improper acceleration behavior. Thus, the method may include detecting and/or measuring an actuated accelerator pedal travel and/or an actuated accelerator pedal travel per time.

Alternatively, or cumulatively, simple, rapid, and cost-efficient detection of a current acceleration behavior or an improper acceleration behavior of a driver of a motor vehicle may be determined by measurements taken at an exhaust system of the motor vehicle. For example, the method may comprise measuring a current exhaust gas composition and then using that detected data for assessing current acceleration behavior or an improper acceleration behavior of a driver of a motor vehicle. The method may include using a lambda probe for detecting the data at the exhaust system.

To avoid hindering regular applications, such as an initial acceleration in new driving stages, the method may include preventing the control of an operation of the motor vehicle when a driving stage is changed.

Some aspects of the invention may comprise using a temperature sensor and/or a wind sensor and/or a pressure sensor for providing a particularly exact determination of a current acceleration behavior of a driver of a motor vehicle and a particularly reliable determination of an improper acceleration behavior.

An improper acceleration behavior of a driver of a motor vehicle can be determined reliably in a simple cost-effective manner by comparing sensed data with reference values. Thus, a number of acceleration operations and/or the intensity of the acceleration operations and/or a predetermined time period can be taken into account for detecting an improper acceleration behavior. For example, an improper acceleration behavior of a driver of a motor vehicle can be defined as a number of more than three acceleration operations via an accelerator pedal movement of more than 5 cm within a period of 30 seconds.

Safety aspects of driving may be part of the method disclosed herein by controlling an operation of the motor vehicle while taking into account at least one of the following variables: a current driving situation, a current vehicle speed, a current traffic volume, current road conditions, use of a sensor unit, use of a processing unit.

To reduce traction wear and/or an emission, the method may respond to a determined improper acceleration behavior by reducing an acceleration available for operation of the motor vehicle to a speed of <1500 m/min. It is understood that in addition to reducing the speed to an absolute value, the speed can also be reduced as a percentage, for example 50% of a detected speed.

Some aspects of the method may include informing a driver and increasing the driver's attention to potential hazards or safety problems by sending an alert when an improper acceleration behavior is determined. An alert may be transmitted only when a threshold value is exceeded.

It will also be appreciated that individual, several, or all mandatory and/or optional steps of the method can be carried out in the proposed sequence, or in deviation from the proposed sequence. Thus, individual, several, or all mandatory and/or optional steps of the method can be repeated, e.g., repeated cyclically. Additionally, individual, multiple, or all of the mandatory and optional steps of the method according to the invention can be performed automatically, in particular by a computer.

This disclosure also relates to a system for detecting incorrect operation of a motor vehicle, and/or for performing some aspects of the method described herein. The system comprises a sensor for detecting data indicative of a current acceleration behavior of a driver of the motor vehicle, a processing unit for determining the current acceleration behavior of the driver of the motor vehicle based on the detected data, and a control unit for controlling operation of the motor vehicle based on the determined current acceleration behavior. The system may be configured to reduce acceleration available for operation of the motor vehicle when an improper acceleration behavior is detected. The system thus has the advantages of the above-described method.

This disclosure also relates to a motor vehicle comprising the system described above. The motor vehicle thus has the same advantages as described with respect to the method and the system described herein.

This disclosure also relates to a computer program product comprising instructions that cause the system to perform the method steps described herein.

Furthermore, the invention relates to a computer-readable non-volatile storage medium on which such a computer program product is stored. The computer program product and storage means collectively offer the advantages described above.

The computer program product can be implemented as a computer-readable instruction code in any suitable programming language and/or machine language, for example in JAVA, C++, C#, and/or Python. The computer program product can be stored on a computer-readable storage medium such as a data disk, a removable drive, a volatile or non-volatile memory, or a built-in memory/processor. The instruction code can program a computer or other programmable devices, such as a controller that may be a component of the control system, such that they carry out the desired functions. Furthermore, the computer program product can be provided on a network, for example the internet, from which it can be downloaded by a user, as needed. The computer program product can be realized by software as well as by means of one or more special electronic circuit systems, i.e., in hardware, or in any hybrid form by means of software components and hardware components. The computer program product according to the invention thus has the same advantages as already extensively described with respect to the method according to the invention and the system according to the invention

Further advantages, features, and details of the invention arise from the following description, in which embodiments are described in detail with reference to the drawings. The features mentioned in the claims and in the description can be essential to the invention individually or in any combination.

### BRIEF DESCRIPTION OF THE DRAWINGS

FIG. 1 schematically indicates the individual steps of a method according to the invention for detecting incorrect operation of a motor vehicle.

FIG. 2 illustrates a motor vehicle with a system according to the invention for detecting incorrect operation of a motor vehicle.

### DETAILED DESCRIPTION

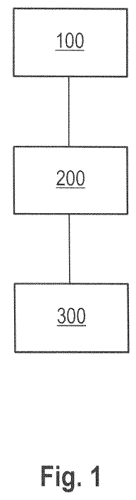

FIG. 1 shows the individual steps of a method according to the invention for detecting incorrect operation of a motor vehicle 80.

As shown in FIG. 1, the method comprises a step 100 of using at least one sensor unit 20 for detecting data indicative of a current acceleration behavior of a driver of the motor vehicle 80, a step 200 of using a processing unit 22 for determining the current acceleration behavior of the driver of the motor vehicle 80 based on the data detected in step 100, and a step 300 of using a control unit 24 for controlling an operation of the motor vehicle 80 based on the current acceleration behavior as determined in the step 200. Detection of an improper acceleration behavior causes a reduction of the maximum speed available for operation of the motor vehicle 80.

The step 100 of detecting data indicative of a current acceleration behavior of a driver of the motor vehicle 80 can advantageously take place at an accelerator pedal of the motor vehicle 80. More particularly, an accelerator pedal travel and/or an actuated accelerator pedal travel per time unit can be detected as data.

Alternatively or cumulatively, detecting 100 data indicative of a current acceleration behavior of a driver of the motor vehicle 80 may also take place at an exhaust gas system of the motor vehicle 80. For example, current exhaust gas composition may be detected as data.

The step 300 of controlling an operation of the motor vehicle 80 may be prevented if a driving stage is changed or being changed, such as a passing maneuver.

Furthermore, the step 100 of detecting data indicative of a current acceleration behavior of a driver of the motor vehicle 80 can detect data by means of a sensor unit 20 comprising a temperature sensor, a wind sensor and/or a pressure sensor.

Detecting an improper acceleration behavior may take place based on a comparison with reference values. A number of the acceleration operations and/or the intensity of the acceleration operations and/or a predetermined time period may be taken into account for the detection of an improper acceleration behavior.

When an improper acceleration behavior is determined, an acceleration available for operation of the motor vehicle 80 can be reduced to a speed of <1500 m/min.

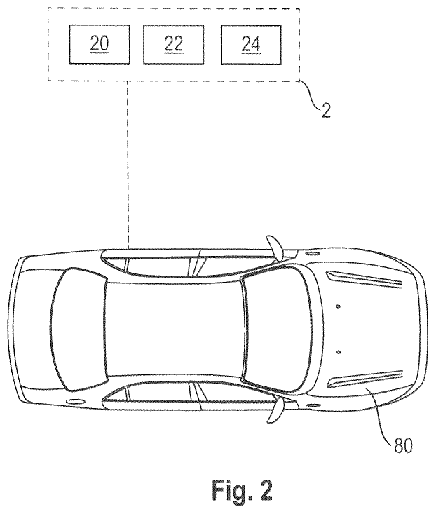

FIG. 2 shows a motor vehicle 80 with a system 2 according to the invention for detecting incorrect operation of a motor vehicle 80.

The system 2 of the invention comprises a sensor unit 20 for detecting 100 data indicative of a current acceleration behavior of a driver of the motor vehicle 80, a processing unit 22 for determining 200 the current acceleration behavior of the driver of the motor vehicle 80, and a control unit 24 for controlling 300 an operation of the motor vehicle 80 based on the determined current acceleration behavior. The system 2 is configured such that, when an improper acceleration behavior is detected, an acceleration available for operation of the motor vehicle 80 can be reduced.

The above explanation describes the present invention solely in the context of examples. Individual features can be combined freely with one another insofar as they are technically advantageous without departing from the scope of the invention.

1. A method for detecting and controlling incorrect operation of a motor vehicle (80), comprising:
using at least one sensor unit (20) for detecting data indicative of a current acceleration behavior of a driver of the motor vehicle (80);
using a processing unit (22) for determining (200) the current acceleration behavior of the driver of the motor vehicle (80) based on the data indicative of the current acceleration behavior of a driver of the motor vehicle (80);
using a control unit (24) for controlling (300) an operation of the motor vehicle (80) based on the determined current acceleration behavior determined by the processing unit (22); and
reducing a maximum speed available for operation of the motor vehicle (80) when an improper acceleration behavior is detected.

2. The method of claim 1, wherein detecting data indicative of a current acceleration behavior of a driver of the motor vehicle (80) comprises detecting an actuated accelerator pedal travel and/or an actuated accelerator pedal travel per time.

3. The method of claim 1, wherein the at least one sensor unit (20) comprises a lambda sensor, and detecting (100) data indicative of a current acceleration behavior of the driver of the motor vehicle (80) takes place at an exhaust gas system of the motor vehicle (80) and includes using the lambda sensor for detecting a current exhaust gas composition.

4. The method of claim 1, further comprising preventing controlling (300) an operation of the motor vehicle (80) if a driving stage is changed.

5. The method of claim 1, wherein the sensor unit (20) comprises a temperature sensor, and detecting (100) data indicative of a current acceleration behavior of a driver of the motor vehicle (80) comprises using the temperature sensor.

6. The method of claim 1, wherein the sensor unit (20) comprises a wind sensor, and detecting (100) data indicative of a current acceleration behavior of a driver of the motor vehicle (80) comprises using the wind sensor.

7. The method of claim 1, wherein the sensor unit (20) comprises a pressure sensor, and detecting (100) data indicative of a current acceleration behavior of a driver of the motor vehicle (80) comprises using the pressure sensor.

8. The method of claim 1, wherein detecting an improper acceleration behavior includes comparing the data indicative of the current acceleration behavior of a driver of the motor vehicle (80) with reference values that include at least one of: a number of acceleration operations, an intensity of the acceleration operations and a predetermined time period during which the acceleration operations take place.

9. The method of claim 1, wherein controlling (300) an operation of the motor vehicle (80) takes place with consideration of at least one of: a current driving situation, a current vehicle speed, a current traffic volume, a current road condition, characteristics of the sensor unit (20), and characteristics of the processing unit (22).

10. The method of claim 1, wherein reducing the maximum speed available for operation of the motor vehicle (80) when an improper acceleration behavior is detected comprises reducing the speed to <1500 m/min.

11. The method of claim 1, further comprising emitting an alert when an improper acceleration behavior exceeds a threshold value.

12. A system (2) for detecting incorrect operation of a motor vehicle (80), comprising:
at least one sensor unit (20) for detecting (100) data indicative of a current acceleration behavior of a driver of the motor vehicle (80),
a processing unit (22) for determining (200) the current acceleration behavior of the driver of the motor vehicle (80) based on the data detected by the at least one sensor unit (20),
a control unit (24) for controlling (300) an operation of the motor vehicle (80) based on the determined current acceleration behavior, wherein the controlling of the operation of the motor vehicle includes reducing an acceleration available for operation of the motor vehicle (80).

13. A motor vehicle comprising the system (2) of claim 12.
